(19) United States
(12) Patent Application Publication
(10) Pub. No.: US 2013/0319359 A1
(43) Pub. Date: Dec. 5, 2013

(54) System And Method For Energy Recovery In A Hydrogen Or Natural Gas Engine

(71) Applicant: Dale Michael Evans, Windsor, WI (US)

(72) Inventor: Dale Michael Evans, Windsor, WI (US)

(21) Appl. No.: 13/482,383

(22) Filed: May 29, 2012

(51) Int. Cl. F02B 43/10; F03G 7/00

(52) U.S. Cl. 123/1 A; 60/327

(57) ABSTRACT

A method and system for energy recovery in a hydrogen or natural gas hybrid electric vehicle includes a turbine positioned between a compressed hydrogen or natural gas storage cylinder and an internal combustion engine. The turbine receives the compressed gas from the storage cylinder, reduces the pressure of the compressed gas, and supplies the compressed gas at a reduced pressure to the internal combustion engine. The turbine is connected to a generator and uses energy extracted from the pressure reduction of the compressed gas to drive the generator. The generator is further connected to a battery of the hybrid electric vehicle and acts as a power source for the battery.

### CROSS REFERENCES TO RELATED APPLICATIONS

Not Applicable

### STATEMENT REGARDING FEDERALLY SPONSORED RESEARCH

Not Applicable.

### BACKGROUND OF INVENTION

Hydrogen and natural gas are cleaner, safer, and more readily available than petroleum-based fuels, making hydrogen and natural gas vehicles an attractive and more economical alternative to conventional petroleum fuel vehicles. A downside to using either hydrogen or natural gas as fuel for a vehicle is the energy that must be expended to compress the gas into a high-pressure tank or cylinder for storage within the vehicle. When the compressed gas is required by the vehicle engine, it is released from the cylinder and must pass through a pressure regulator that expands the gas to almost atmospheric pressure.

### SUMMARY OF THE INVENTION

The present invention provides a power train for a hybrid electric vehicle. The power train includes a storage cylinder storing a compressed gas, an internal combustion engine, a generator, and a turbine. The turbine is positioned between the storage cylinder and the internal combustion engine and receives the compressed gas from the storage cylinder, reduces the pressure of the compressed gas, and supplies the compressed gas at a reduced pressure to the internal combustion engine. The turbine is also connected to the generator and uses energy extracted from the pressure reduction of the compressed gas to drive the generator. The power train also includes a battery connected to the generator. The battery is charged by at least the generator.

The present invention also provides a method for energy recovery in a hybrid electric vehicle. The method includes passing a compressed gas from a storage tank, through a turbine, to an internal combustion engine, expanding the compressed gas as it passes through the turbine, and recovering energy released from the gas expansion through motion of the turbine. The method also includes converting motion of the turbine to electric energy using a generator connected to the turbine and transferring the electric energy to a battery of the hybrid electric vehicle.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a block diagram of a power train, according to one embodiment of the invention, for a hybrid electric vehicle.

FIGS. 2a and 2b are block diagrams of fuel compression and storage for the power train of FIG. 1.

FIG. 3 is flow chart illustrating a method for recovering energy in a hybrid electric vehicle.

### DETAILED DESCRIPTION OF THE INVENTION

The present invention provides energy recovery solutions for a hybrid electrical vehicle using a compressed, combustible gas, such as hydrogen or natural gas. In such hybrid electrical vehicles, a turbine is positioned between the compressed gas storage cylinder and the internal combustion engine. The turbine reduces the pressure of the compressed gas from its storage pressure to a pressure usable by the internal combustion engine and uses the energy extracted from the pressure reduction to the drive a generator. The additional power generated by the generator can be used to charge a battery powering the vehicle's electric motor. Hybrid vehicles can also include a Stirling engine and second generator positioned to receive and extract energy from the hot exhaust of the internal combustion engine.

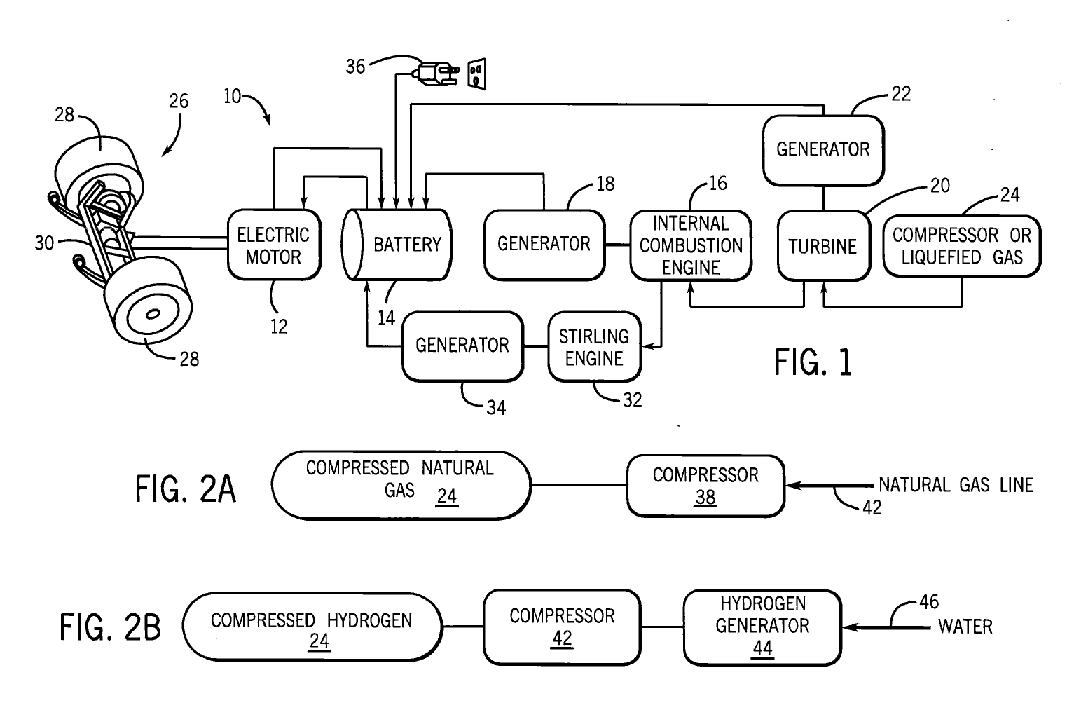

FIG. 1 illustrates a power train 10, according to one embodiment of the invention, for a hybrid electric vehicle. The power train 10 includes an electric motor 12, a battery 14, an internal combustion engine 16 coupled to a first generator 18, a turbine 20 coupled to a second generator 22, a fuel storage tank or cylinder 24, and a final drive 26 including drive wheels 28 and a differential gear 30. In a hydrogen hybrid electric vehicle, the fuel storage cylinder 24 stores compressed hydrogen. In a natural gas hybrid electric vehicle, the fuel storage cylinder 24 stores compressed natural gas or liquefied natural gas. The power train 10 can also include a Stirling engine 32 coupled to a third generator 34, as shown in FIG. 1. The power train 10 of either a hydrogen or natural gas hybrid electric vehicle also includes additional components not illustrated in FIG. 1, such as motor controllers.

The power train 10 of FIG. 1 illustrates a series hybrid configuration, where the final drive 26 is driven only by the electric motor 12. Other embodiments can include a power train 10 with a parallel hybrid configuration, where both the internal combustion engine 16 and the electric motor 12 are capable of driving the final drive 26. In such parallel hybrid configurations, the internal combustion engine 16 and the electric motor 12 are both coupled to the final drive 26 (e.g., through an additional differential, not shown). In addition, other embodiments can include multiple electric motors 12, such as two electric motors 12 (e.g., one electric motor 12 driving the front drive wheels 28 and a second electric motor 12 driving the rear drive wheels 28), or four electric motors 12 (e.g., each drive wheel 28 is individually driven by a respective electric motor 12). The power train can also include more than one battery 14 in the single electric motor, two electric motor, or four electric motor configurations.

As described above, the electric motor 12 of the power train 10 drives the final drive 26. The electric motor 12 is connected to and powered by the battery 14, which is further connected to a plug 36 (shown in FIG. 1), the first generator 18, the second generator 22, and the third generator 34. The battery 14 can be charged by receiving power or electrical energy input from the electric motor 12, the plug 36, the first generator 18, the second generator 22, and/or the third generator 34. More specifically, the battery 14 can be charged by a combination of one or more of the following methods. A first method for charging the battery 14 is through electrical connection to an external power source (i.e., via the plug 36 connected to an outlet 38, as shown in FIG. 1), and a second method for charging the battery 14 is through regenerative braking (i.e., via the electric motor 14 acting as a generator).

A third method for charging the battery 14 is through energy generated by the internal combustion engine 16 (i.e., via the first generator 18). The internal combustion engine 16 operates by combusting a mixture of hydrogen and air, or natural gas and air, and converting the energy released by the combustion to kinetic energy, which is then used to drive the first generator 18 for providing power to the battery 14. The hydrogen or natural gas stored in the fuel storage cylinder 24 must first be conditioned so that it is at an optimal pressure and/or temperature for use by the internal combustion engine 16. For example, compressed hydrogen or compressed natural gas must be stored at very high pressures, but the pressure must be reduced to near atmospheric pressure for use with the internal combustion engine 16. This pressure reduction is conventionally carried out by a pressure regulator. In the present invention, the pressure reduction is carried out by the turbine 20, either alone or in conjunction with a pressure regulator. In another example, liquefied natural gas is stored at very low temperatures and must be heated, or vaporized, for use with the internal combustion engine 16.

A fourth method for charging the battery 14 is through energy generated by the turbine 20 (i.e., via the second generator 22). As described above, the turbine 20 replaces or works in conjunction with a pressure regulator in order to reduce the pressure of the stored compressed gas before it is supplied to the internal combustion engine 16. The energy released by the pressure reduction, which is conventionally expelled as heat, can be recovered by the turbine 20. More specifically, as the compressed gas passes through the turbine 20, expansion (i.e., pressure reduction) of the compressed gas causes rotation of the turbine 20, which then drives the second generator 22 for providing power to the battery 14. As a result, the energy originally input to compress the gas so that it is suitable for storage in the fuel storage cylinder 24 (e.g., through a compressor 38 from a natural gas line 40, as shown in FIG. 2a, or a compressor 42 from a hydrogen generator 44 and a water source 46, as shown in FIG. 2b) can be recovered by the turbine 20 and the second generator 22 when the compressed gas is expanded for use by the internal combustion engine 16.

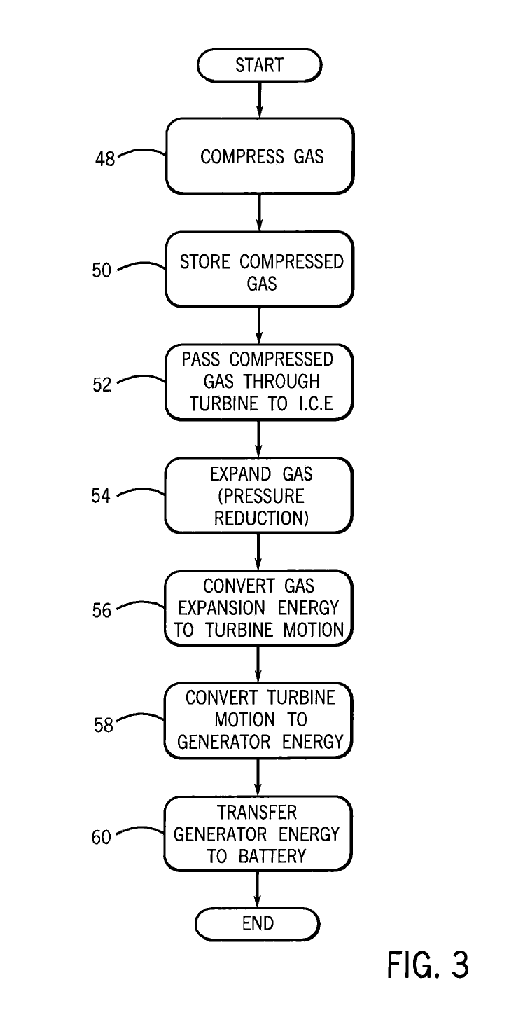

FIG. 3 is a flow diagram illustrating the above-described method for recovering energy through the turbine 20. The gas is first compressed, via the compressor 38 or 42, (at step 48) and then stored in the fuel storage cylinder 24 at a high pressure at step 50. The high pressure, compressed gas is then passed through the turbine 20 (at step 52) before it reaches the internal combustion engine 16 and is expanded as it passes through the turbine 20 at step 54. The expansion of the compressed gas releases energy which causes motion (i.e., rotation) of the turbine 20 at step 56. Motion of the turbine 20 is converted to electrical energy using the second generator 22 connected to the turbine 20 at step 58. The electrical energy generated by the second generator 22 is then transferred to the battery 14 at step 60 as at least one source of power for charging the battery 14.

A fifth method for charging the battery 14 is through energy generated by the Stirling engine 32 (i.e., via the third generator 34). As described above, the internal combustion engine 16 operates by combusting a mixture of fuel and air. For example, using hydrogen as the fuel component, the byproduct of the combusted fuel/air mixture is water. Conventionally, the water, at a substantially high temperature, is merely exhausted by the internal combustion engine 16 into the air outside the vehicle. In the present invention, the hot water exhaust can be used as an external heat source to operate the Stirling engine 32 for additional energy recovery. More specifically, a sealed gas inside the Stirling engine 32 is heated by the hot water exhaust, causing a pressure increase inside the engine and subsequent movement of pistons inside the Stirling engine 32, which then drive the third generator 34 for providing power to the battery 14. The Stirling engine 32 can be heated, and perform as described above, by engine exhaust other than hot water, for example from engines using other fuel sources such as natural gas or conventional petroleum fuels.

The above-described power train 10 and energy recovery methods can be used in any type of hydrogen or natural gas hybrid electric vehicle including, but not limited to, hybrid electric cars, trucks, tractors, buses, trains, boats and/or planes. In addition, a combination of one or more of the components described above with respect to the power train 10 can be used in power generation systems for applications other than vehicles. For example, the energy recovery methods, including using a turbine located upstream from a combustion engine, or combustion chamber, to expand a compressed gas from a fuel source and supply the expanded gas to the combustion chamber, can be used in additional applications. In any such applications, including those which include a single of multiple combustion chambers, the turbine can be located upstream from all combustion chambers (i.e., essentially acting as a pre-combustion turbine). In another example, a boat power train can include solar cells and a hydrogen-fueled internal combustion engine. The solar cells can generate power to operate a compressor for compressing or liquefying hydrogen gas, which can then be stored in a cylinder as fuel for use by the internal combustion engine (and resulting in water being the only byproduct of boat operation). Rather than the energy generated by the solar cells being stored in a battery for use by an electric motor, the generated energy is essentially stored as the compressed or liquefied gas itself, for later use by the internal combustion engine.

While there has been shown and described what are at present considered the preferred embodiments of the invention, it will be obvious to those skilled in the art that various changes and modifications can be made therein without departing from the scope of the invention defined by the appended claims.

I claim:

1. A power train for a hybrid electric vehicle, the power train comprising:
a storage cylinder storing a compressed gas;
an internal combustion engine;
a generator;
a turbine positioned between said storage cylinder and said internal combustion engine and connected to said generator, said turbine receiving said compressed gas from said storage cylinder, reducing a pressure of said compressed gas, and supplying said compressed gas at a reduced pressure to said internal combustion engine, said turbine using energy extracted from the pressure reduction of said compressed gas to drive said generator; and
a battery connected to said generator and being charged by at least said generator.

2. The power train as in claim 1, in which the compressed gas is one of compressed hydrogen gas and compressed natural gas.

3. The power train as in claim 1, including a Stirling engine coupled to a second generator, said Stirling engine extracting energy from exhaust gas of said internal combustion engine to drive said second generator, and said second generator being connected to said battery and charging said battery.

4. The power train as in claim 1, including a third generator connected to said internal combustion engine and said battery, said third generator being driven by said internal combustion engine to charge said battery.

5. The power train as in claim 1, including an electric motor and a final drive, wherein said electric motor is powered by said battery to operate said final drive, wherein said electric motor charges said battery through regenerative braking of said final drive.

6. The power train as in claim 5, wherein said electric motor and said internal combustion engine are configured relative to said final drive in a series hybrid configuration.

7. The power train as in claim 5, wherein said electric motor and said internal combustion engine are configured relative to said final drive in a parallel hybrid configuration.

8. The power train as in claim 7, wherein said internal combustion engine is connected to and operates said final drive.

9. A method for energy recovery in a hybrid electric vehicle, said method comprising:
passing a compressed gas from a storage tank, through a turbine, to an internal combustion engine;
expanding said compressed gas as it passes through said turbine;
recovering energy released from said expanding of said compressed gas through motion of said turbine;
converting motion of said turbine to electric energy using a generator connected to said turbine; and
transferring said electric energy to a battery of said hybrid electric vehicle.

10. The method as in claim 9, including the steps of mixing said compressed gas with air to form a gas-air mixture once it enters said internal combustion engine, combusting said gas-air mixture, exhausting said gas-air mixture after it has been combusted, applying said gas-air mixture after it has been exhausted to a Stirling engine as a heat source, recovering energy from said heat source through motion of said Stirling engine, converting motion of said Stirling engine to additional electric energy using a second generator connected to said Stirling engine, and transferring said additional electric energy to said battery.

11. The method as in claim 9, wherein said compressed gas is one of compressed hydrogen and compressed natural gas.
